(19) United States
(12) Patent Application Publication
(10) Pub. No.: US 2005/0092175 A1
(43) Pub. Date: May 5, 2005

(54) Noble metal gas barriers

(76) Inventor: G.B. Kirby Meacham, Shaker Heights, OH (US)

Correspondence Address: MEACHAM COMPANY, 18560 PARKLAND DRIVE, SHAKER HEIGHTS, OH, 44122, US

(21) Appl. No.: 10/696,251

(22) Filed: Oct. 29, 2003

(51) Int. Cl. B01D 53/22

(52) U.S. Cl. 95/45

(57) ABSTRACT

The present invention includes noble metal bipolar separators and seals for solid oxide fuel cells. Controlled porosity vents steam formed within the separator by the reaction of hydrogen diffusing from one side with oxygen diffusing from the other. This venting prevents the buildup of destructive pressure within the separator while retaining the required gas separation and electronic conductivity properties. The principle of the invention applies to applications other than solid oxide fuel cells, and includes materials other than noble metals.

### CROSS-REFERENCE TO RELATED APPLICATIONS

Not Applicable

### STATEMENT REGARDING FEDERALLY SPONSORED RESERCH OR DEVELOPMENT

Not Applicable

### REFERENCE TO A MICROFICHE APPENDIX

Not Applicable

### BACKGROUND OF THE INVENTION

The proposed concept is related to barriers that separate fuel and oxidant gases in high temperature solid oxide fuel cells (SOFC) and cell stacks and similar apparatus. In particular, it relates to means to control the diffusion and reaction of oxygen and hydrogen gas within noble metal metallic barrier structures and prevent barrier damage.

The background of the invention includes bipolar separators and seals that separate fuel and oxidant gases in SOFC systems and other high temperature apparatus.

Fuel cells are electrochemical systems that generate electrical current by chemically reacting a fuel gas and an oxidant gas on the surfaces of electrodes. Conventionally, the oxidant gas is oxygen or air, and in high temperature (600° C. to 1000° C.) SOFC the fuel gas is hydrogen or a mixture of hydrogen, carbon monoxide, and traces of hydrocarbons. The fuel gas may also contain non-fuel gases including nitrogen, water vapor and carbon dioxide. Each cell produces a potential of less than 1 volt, so multiple cells are typically connected in series to produce a higher, more useful voltage. The series interconnection is often accomplished by constructing a bipolar stack of planar cells such that current flows from the anode of one cell to the cathode of the next. The stack output current is collected from the top and bottom cells at a voltage equal to the sum of the voltages of the individual cells. Fuel gas and the oxidant gas must be supplied to each cell in the stack, while being kept separate so that they do not react with each other except on the surfaces of the electrodes. Direct reactions cause a loss in energy conversion efficiency, and may generate high temperatures that damage the cell or stack structures. Barrier structures that separate fuel gas and oxidant gas are therefore required elements in fuel cell stacks. Two types of barrier exemplify these structures: bipolar plates and seal gaskets.

A bipolar separator connects the anode of each cell in a stack to the cathode of the adjacent cell. These bipolar separators are in contact with the fuel gas on the anode side and the oxidant gas on the cathode side, and must be largely impermeable to these gases. In addition, they must be electronic conductors able to carry the current from one cell to the next. Further, they must be ionic non-conductors to avoid unwanted reactions between the fuel and oxidant gases. Finally, they must not deteriorate from interactions with the fuel and oxidant gases at the elevated operating temperatures, and must have thermal expansion characteristics compatible with the adjacent cells.

A number of metals and alloys have been investigated for use as separator plates. In general, pure metals and alloys that resist oxidation damage do so by forming an adherent oxide layer that is a barrier to further oxygen attack. While this protects the bulk metal, the oxides are generally electronic insulators and severely restrict current flow. Chromium alloys such as high chromium ferric steel are an exception, and form an electronically conductive, adherent oxide. An example is iron with 18% chromium and 1% aluminum. One problem with such alloys is that the chromium forms volatile compounds in an oxidizing environment at the operating temperatures. These migrate and degrade other cell components, particularly the cathode-electrolyte interface, as described in U.S. Pat. No. 6,444,340 (Jaffrey) and U.S. Pat. No. 5,942,349 (Badwal et al.). Jaffrey eliminates chromium by using noble metal conductors between the cathode and anode sides of a nonconductive bipolar separator to form the electrical interconnection. U.S. Pat. No. 6,183,897 (Hartvigsen et al.) uses a related approach. Badwal et al. apply an coating to the cathode side of a chromium-containing bipolar separator that captures and sequesters chromium-containing vapor. U.S. Pat. No. 6,280,868 (Badwal et al.) describes nickel and chromium interdiffusion and oxidation problems on the anode side of a chromium-containing bipolar separator, and applies one or more noble metal layers as a protective barrier. Chromium alloy bipolar separators are therefore, at best, less than ideal.

Doped lanthanum chromite provides a nonmetallic alternative. It is an electronically conductive, ionically non-conductive relatively impermeable ceramic. It is compatible with the fuel and oxidant gases, does not form chromium vapors, and has favorable expansion properties. It has been used successfully as a bipolar separator in two forms: self-supporting separator plates made from bulk material and thin films applied to cathode surfaces. U.S. Pat. No. 5,958,304 (Khandkar), et al. provides an example of formulations and processes for making self-supporting doped lanthanum-chromite separator plates. Such plates function well, but the cost, weight and volume are high. Thin (30 to 100 micron) doped lanthanum chromite films applied to the cathode are a potential improvement. Application methods include electrochemical vapor deposition (EVD) and plasma spray with high temperature heat treatment to reduce porosity. These methods are described in U.S. Pat. No. 5.391,440 (Kuo, et al.). They involve processing steps at 1350° C. to 1450° C. that are time-consuming and expensive. These high firing temperatures may damage other components, limiting its use in fabrication approaches where multiple cell components are combined green and co-fired. Further, the range of compositions that can be applied by EVD are limited, resulting in non-optimum thermal expansion and conductivity.

Seal gaskets are similar to bipolar separators in that they also form barriers between fuel and oxidant gases. They are somewhat compliant structures that are penetrated by one or more openings, and are clamped in gaps between stack components. The compliance allows the seal gaskets to conform to the mating surfaces to form a barrier to gas flow through the gaps. Flow is blocked between internal openings and the exterior edge of the gasket, and from one internal opening to another. Some seal surfaces contact fuel gas, and other surfaces contact oxidant gas, resulting in requirements similar to bipolar separators. They must be ionic non-conductors, and largely impermeable to the fuel and oxidant gases. Further, they must not deteriorate from interactions with the fuel and oxidant gases at the elevated operating temperatures, and must have thermal expansion characteristics compatible with the adjacent cells. They differ from bipolar separators in that they do not necessarily need to be electronic conductors.

Glass based seal gaskets are described and discussed in U.S. Pat. No. 5,453,331 (Bloom, et al.) and U.S. Pat. No. 6,271,158 (Xue, et al.). The glass and filler are selected such that the seal is somewhat viscous and compliant at the cell operating temperature, and thereby adjusts to fill the gaps. One problem is that the seals transition to elastic solids as the cell and stack assembly cools. This may generate significant stresses unless the solids are a good thermal expansion match with the cell and stack components. Another problem is that glasses often wet the cell and stack materials, and therefore migrate from their original locations. A further problem is that the glasses tend to interdiffuse with the cell materials, changing the properties of both substances.

U.S. Pat. No. 6,106,967 (Virkar, et al.) addresses the problems of glass seals by employing a thin metallic foil as a combined bipolar separator and sealing gasket. It is compliant enough in compression to conform to the mating surfaces and provide a seal. Further, it is thin enough it does not generate excessive thermal stresses even with some mismatch in thermal expansion characteristics. Virkar et al. indicate that the foil should be a superalloy containing chromium, which leads to the difficulties with chromium discussed above.

Noble metal, in particular silver, has been considered as a material for bipolar separators and seals since it has high electrical conductivity and does not form an oxide layer in air or fuel atmospheres at SOFC operating temperatures. While its thermal expansion coefficient is higher than the ceramic cell components, its ductility is high and should not generate excessive thermal stresses in thin sections. Experimental results, however, have not been promising to date. Dr. Prabhakar Singh of the Pacific Northwest National Laboratory reported on the high temperature properties of silver in session Fuel 3.6 at the ASM Conference in Pittsburgh, Pennsylvania on Oct. 14, 2003. While durability was excellent when both sides of a silver barrier were exposed to either air or wet hydrogen at 500° C. to 700° C., the barrier disintegrated in tests where one side was exposed to air and the other side was exposed to wet hydrogen at the same temperature. The result was attributed to steam generated within the silver by the reaction of oxygen diffusing from one side and hydrogen diffusing from the other side. Dr. Scott Weil of the Pacific Northwest National Laboratory reported on the high temperature properties of silver-copper oxide braze material in session Fuel 10.3 at the ASM Conference in Pittsburgh, Pa. on Oct. 15, 2003. One case described was a braze joint of silver with 4 molar percent copper oxide exposed to hydrogen on one free face and oxygen on the other free face at 750° C. Porosity developed near the free face exposed to hydrogen, and the balance of the joint was unaffected. Detailed data on the growth rate of the porosity affected zone were not presented. The authors indicated that the slow penetration could not be explained by the diffusion rates of oxygen and hydrogen in silver, and no other explanation was offered. Since the silver-copper oxide braze has unique and desirable properties for joining metal and ceramic components at high temperatures, the authors are investigating addition of glass seals to the free face exposed to hydrogen to prevent porosity growth. Aside from the difficulties with glass seals described above, addition of an electronically insulating glass layer to a SOFC bipolar plate would interfere with its current-carrying function. In summary, these presentations portray silver as a material that is not suitable for current-carrying structures separating air and hydrogen at high temperatures.

In conclusion, materials or combinations of materials that combine all the technical characteristics required for durable electrically conductive bipolar separator plates and seals for SOFC cell power generation systems are not described in the prior art.

### BRIEF SUMMARY OF THE INVENTION

The present invention is a means for constructing durable metallic bipolar separators and seals from noble metals, in particular silver. The result is a malleable all-metallic structure without brittle, low-conductivity oxide layers or volatile chromium oxides. The barriers may be freestanding structures. Alternatively, they may be coating layers applied to other fuel cell components including cathodes or anodes.

The invention comprises noble metal barriers that incorporate fluidically connected pores that extend from the barrier surface into the barrier interior. This porosity vents the steam formed by the reaction of the hydrogen diffusing into the barrier from one side and the oxygen diffusing in from the other side, preventing buildup of destructive internal pressure. The porosity may be either on the air side, the fuel side or both. Oxygen and hydrogen do not enter through the pores because of the steam outflow. Instead, they can only enter by diffusion into the exposed metal surface between the pores, limiting the overall hydrogen and oxygen losses to acceptable values

The pores may be formed by a variety of means. For example, the pores may be an intrinsic feature of barriers formed by powder metallurgy. Alternatively, they may be formed indirectly by compounding fully dense materials that develop the required porosity in service.

In summary, the present invention advances the practical application of SOFC by introducing a means of using noble metals to form durable electrically conductive chromia-free ductile metal barriers between fuel and air gases.

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent to those of ordinary skill in the art upon examination of the following detailed description of the invention and claims that follow.

### BRIEF DESCRIPTION OF THE SEVERAL VIEWS OF THE DRAWING

The appended claims set forth those novel features that characterize the invention. However, the invention itself, as well as further objects and advantages thereof, will best be understood by reference to the following detailed description of preferred embodiments. The accompanying drawings, where like reference characters identify like elements throughout the various figures, in which:

FIG. 1 is an illustration of hydrogen and oxygen diffusing into a barrier and reacting to form water vapor which is vented through fluidically connected pores in the fuel side barrier face according to the invention;

FIG. 2 is an illustration of hydrogen and oxygen diffusing into a barrier and reacting to form water vapor which is vented through fluidically connected pores in the air side barrier face according to the invention;

FIG. 3 is an illustration of hydrogen and oxygen diffusing into a barrier and reacting to form water vapor which is vented through fluidically connected pores in the fuel side and air side barrier faces according to the invention;

### DETAILED DESCRIPTION OF THE INVENTION

The present invention relates to metallic barriers and seals that separate fuel and oxidant gases in high temperature systems. The invention is described with respect to high temperature solid oxide fuel cells (SOFC) and cell stacks operating with air and hydrogen-containing fuel gas. However, it will be obvious to those skilled in the art that the following detailed description is similarly applicable to other types of high temperature systems that require barriers and seals between reducing and oxidizing substances.

The barriers and seals according to this invention may be self-supporting structures. Alternatively, they may be coating layers applied to other components including fuel cell cathodes or anodes. The function is the same in both applications.

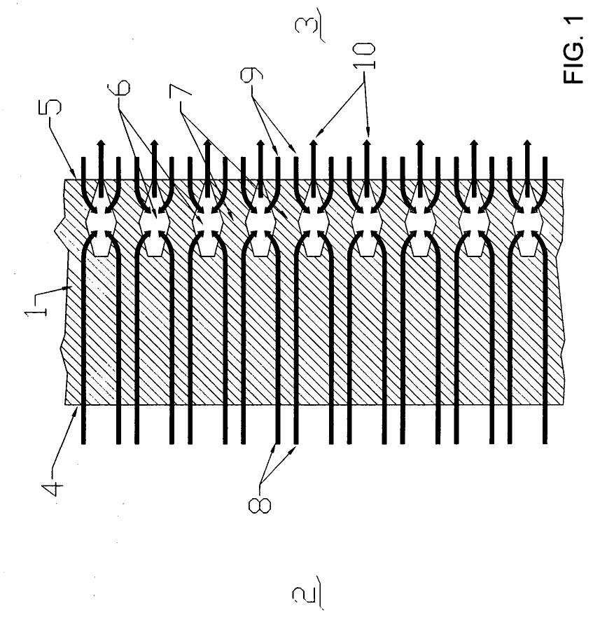

FIG. 1 schematically illustrates the operating principle of a first embodiment of the invention. A barrier 1 separates oxygen-containing air 2 from hydrogen-containing fuel gas 3. Air face 4 of barrier 1 contacts air 2, and fuel face 5 contacts fuel gas 3. Fluidically connected pores 6 extend into barrier 1 from fuel face 5, but do not extend through to air face 4. Conducting bridges 7 provide electrical continuity between air face 4 and fuel face 5. Air face 4 and at least a portion of the thickness of barrier 1 is composed of noble metal such as silver or gold that does not form an oxide layer in the presence of oxygen. Fuel face 5 and the balance of the thickness of barrier 1 is composed of noble metal or a metallic composition stable and electronically conductive in the fuel gas environment. Oxygen 8 diffuses into air face 4 and hydrogen 9 diffuses into fuel face 5, and meet and react within the pores 6. The resulting steam 10 flows out of the pores 6, limiting the internal pressure buildup within barrier 1. The steam flow out of the pores minimizes hydrogen diffusion into the pores, limiting hydrogen diffusion to the solid areas of fuel face 5.

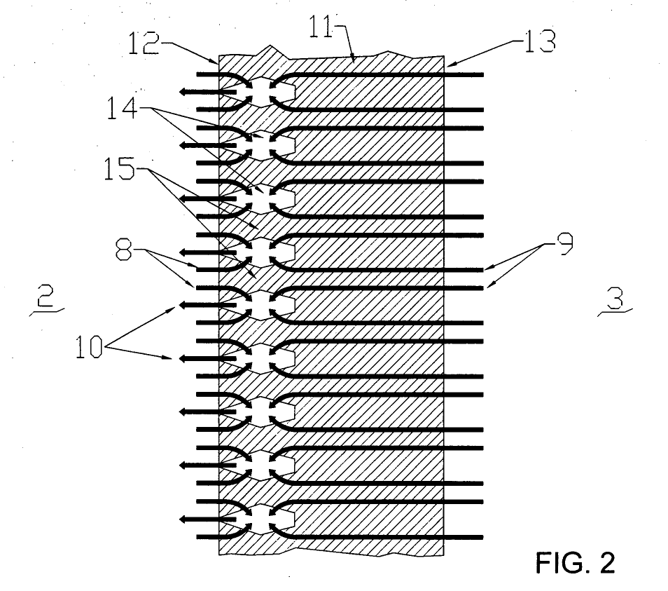

FIG. 2 illustrates the operating principle of a second embodiment of the invention. A barrier 11 separates oxygen-containing air 2 from hydrogen-containing fuel gas 3. Air face 12 of barrier 11 contacts air 2, and fuel face 13 contacts fuel gas 3. Fluidically connected pores 14 extend into barrier 11 from air face 12, but do not extend through to fuel face 13. Conducting bridges 15 provide electrical continuity between air face 12 and fuel face 13. Air face 12 and at least a portion of the thickness of barrier 11 is composed of noble metal such as silver or gold that does not form an oxide layer in the presence of oxygen. Fuel face 13 and the balance of the thickness of barrier 11 is composed of noble metal or a metallic composition stable and electronically conductive in the fuel gas environment. Oxygen 8 diffuses into air face 12 and hydrogen 9 diffuses into fuel face 13, and meet and react within the pores 14. The resulting steam 10 flows out of the pores 14, limiting the internal pressure buildup within barrier 11. The steam flow out of the pores minimizes oxygen diffusion into the pores, limiting oxygen diffusion to the solid areas of air face 12.

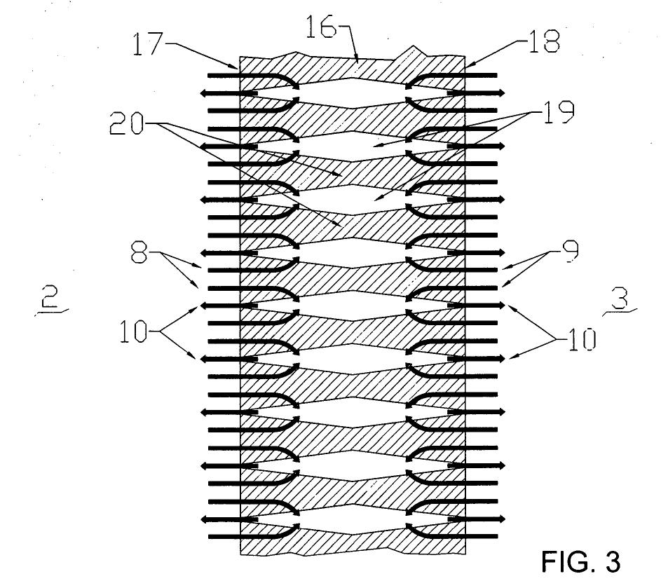

FIG. 3 illustrates the operating principle of a third embodiment of the invention. A barrier 16 separates oxygen-containing air 2 from hydrogen-containing fuel gas 3. Air face 17 of barrier 16 contacts air 2, and fuel face 18 contacts fuel gas 3. Fluidically connected pores 19 extend into barrier 16 from air face 17 and from fuel face 18 and may interconnect fluidically within barrier 16. Conducting bridges 20 provide electrical continuity between air face 17 and fuel face 18. Air face 17 and at least a portion of the thickness of barrier 16 is composed of noble metal such as silver or gold that does not form an oxide layer in the presence of oxygen. Fuel face 18 and the balance of the thickness of barrier 16 is composed of noble metal or a metallic composition stable and electronically conductive in the fuel gas environment. Oxygen 8 diffuses into air face 17 and hydrogen 9 diffuses into fuel face 18, and meet and react within the pores 19 forming steam 10. Preferably, the pores are of such dimensions that the absolute pressure of steam 10 in pores 19 is higher than that of air 2 or fuel gas 3 at the pore openings. This assures that there is flow of steam 10 outward through the pores, preventing bulk inflow of air 2 or fuel gas 3. The steam flow out of the pores minimizes oxygen and hydrogen diffusion into the pores, limiting diffusion of oxygen 8 to the solid areas of air face 17 and diffusion of hydrogen 9 to the solid areas of fuel face 18. The overall result is that bulk flow of fuel gas or air through barrier 16 is blocked by the relatively high pressure steam 10 in pores 179.

The three embodiments of the invention show that a variety of porosity patterns in noble metal barriers vent steam and prevent destructive pressure buildup. The characteristics of the third embodiment are particularly surprising. Fluidically connected pores through a noble metal barrier separating oxygen and hydrogen-containing gases does not cause bulk gas flow through the barrier. The porosity acts only as a steam vent, and the hydrogen and oxygen flow is governed by the diffusion of the gasses in the metal. The conclusion is that the invention provides robust barriers that do not rely on precise control of porosity, and accommodate changes in porosity over the operating life of the barrier.

The air side of the barrier, whether porous or solid, is noble metal or a composite of noble metal and non-reactive material such as ceramic that will not form a surface oxide layer in air at SOFC operating temperatures. The hydrogen side may be noble metal or other metals, metal alloys or cermets that are electronically conductive and stable in the fuel gas mixture. Examples of such metallic compositions include alloys or mixtures of non-noble and noble metals such as nickel, copper, cobalt, silver and gold. Additional examples include cermet compositions in which particles composed of ceramics stable in a reducing fuel gas atmosphere are combined with the previously mentioned metals. Such ceramics include alumina, zirconia or lanthanum chromite, and may serve to reduce material cost and modify physical properties such as the coefficient of thermal expansion. It should be noted that fuel gas often contains water vapor, nitrogen, carbon dioxide, carbon monoxide, and hydrocarbons in addition to hydrogen. In particular, resistance to carbide formation may be a consideration. Further, non-noble materials contacting the noble metal must exhibit acceptable rates of interdiffusion and other reactions with the noble metal at the operating temperature.

A number of means are available to form porous metallic structures, and use of any such means is within the scope of this invention. The following methods are presented as examples. Powder metallurgy is a direct means of producing such structures. Electronically conductive metal powder is a major ingredient, and other elements including non-reactive ceramic particles may be included. The ingredients are mixed, pressed and sintered to produce a porous structure. The porosity is controlled by the choice of ingredients and the processing conditions. The ingredients may include fugitive pore formers that burn out during sintering. Porous barriers may be also be formed indirectly by compounding materials that develop increased porosity in service. Copper oxide inclusions in silver, for example, reduce to copper metal when exposed to hydrogen. The copper metal has a smaller volume than the oxide, resulting in the formation of pore volume. Nickel oxide in noble metal is expected to have similar properties.

While the prior discussion has concerned electronically conductive barriers, the basic principle of the invention is more broadly applicable. Consider a barrier material separating gas A from gas B, where gasses A and B are both soluble in and diffuse through the barrier material. If gasses A and B react with each other within the barrier material to form a product gas C which is substantially insoluble in the barrier material, high pressure may develop and physically disrupt the material. According to the invention, a network of fluidically interconnected pores leads from the reaction area within the barrier to the barrier surface to vent the product gas C and limit its pressure. Preferably, the pores are of such dimensions that the absolute pressure of product gas C in a pore is higher than that of gas A or gas C at the pore opening. This assures that there is a flow of C outward through the pores, preventing bulk inflow or through-flow of A or B. The upper limit of the absolute pressure of C within the barrier is determined by the physical strength of the barrier. This principle is clearly applicable to a range of ceramic, glass and composite materials in addition to metals and conductive cermets.

The foregoing embodiments of the present invention have been presented for the purposes of illustration and description. These descriptions and embodiments are not intended to be exhaustive or to limit the invention to the precise form disclosed, and obviously many modifications and variations are possible in the light of the above disclosure. The embodiments were chosen and described in order to best explain the principle of the invention and its practical applications to thereby enable others skilled in the art to best utilize the invention in its various embodiment and with various modifications as are suited to the particular use contemplated. It intended that the invention be defined by the following claims.

1. A predominantly metallic barrier separating oxygen containing gas and hydrogen containing gas, where at least a portion of the barrier contains fluidically connected pores leading from the barrier interior to the barrier surfaces.

2. The predominantly metallic barrier of claim 1 in which said fluidically connected pores lead to barrier surfaces contacted by hydrogen containing gas.

3. The predominantly metallic barrier of claim 1 in which said fluidically connected pores lead to barrier surfaces contacted by oxygen containing gas.

4. The predominantly metallic barrier of claim 1 in which a portion of said fluidically connected pores lead to barrier surfaces contacted by oxygen containing gas and a portion lead to barrier surfaces contacted by hydrogen containing gas.

5. The predominantly metallic barrier of claim 4 in which at least a portion of said fluidically connected pores extend from barrier surfaces contacted by oxygen containing gas to barrier surfaces contacted by hydrogen containing gas.

6. The predominantly metallic barrier of claim 1 in which at least a portion of said metallic content is a noble metal.

7. The predominantly metallic barrier of claim 6 in which the metal composition of at least the barrier surfaces contacted by oxygen containing gas is predominantly noble metal.

8. The predominantly metallic barrier of claim 7 in which the barrier surfaces contacted by hydrogen containing gas are predominantly non-noble metals including copper and nickel.

9. The predominantly metallic barrier of claim 1 in which at least a portion of the composition is particles of ceramic such as aluminia, zirconia or lanthanum chromite that are stable in both oxygen and hydrogen containing gases.

10. The predominantly metallic barrier of claim 1 in which a portion of the composition is particles of oxide such as copper oxide or nickel oxide that are stable in oxygen containing gases and are reduced to metal in hydrogen containing gases.

11. The predominantly metallic barrier of claim 1 in which a portion of the composition is particles of oxide such as copper oxide or nickel oxide that are stable in oxygen containing gases and are reduced to metal in hydrogen containing gases, and another portion of the composition is particles as aluminia, zirconia or lanthanum chromite that are stable in both oxygen and hydrogen containing gases.

12. A method of separating gas A from gas B with a barrier in which
A. Gasses A and B are both soluble in and diffuse through the barrier material;
B. gasses A and B react with each other within said barrier material to form a product gas C which is substantially insoluble in said barrier material;
C. said barrier contains connected pores leading to the surface of said barrier to vent said product gas C and limit the pressure of said product gas C within said barrier material.

13. The method of claim 12 wherein said gas A contains oxygen, said gas B contains hydrogen and said product gas C is steam.

14. The method of claim 12 wherein said barrier material is essentially inert relative to said gases A and B and said product C.

15. The method of claim 14 wherein the composition of said barrier material is varied according to the position within the barrier such that said gases A, B and product gas C only contact material inert to said gases A, B and product gas C respectively.

16. The method of claim 14 wherein at least a portion of said barrier material is electronically conductive metal.

17. The method of claim 16 wherein at least a portion of said electronically conductive metal is a noble metal.

18. The method of claim 14 wherein at least a portion of said barrier material is an oxide, ceramic or glass.

19. The method of claim 12 wherein the absolute pressure of said product gas C in a pore is higher than that of said gas A or gas B at the pore opening, such that outward flow of said product gas C prevents entry of gasses A or B.

20. The method of claim 12 wherein the absolute pressure of said product gas C in a pore is below a level that causes structural damage to said barrier material.
